(19) United States
(12) Patent Application Publication
(10) Pub. No.: US 2021/0122950 A1
(43) Pub. Date: Apr. 29, 2021

(54) Resistant Aqueous Polymer Dispersion for Adhesive Applications

(71) Applicant: Synthomer (UK) Limited, Essex (GB)

(72) Inventors: Jessica Evans, Duncan, SC (US); Timothy Shreve, Spartanburg, SC (US)

(73) Assignee: Synthomer (UK) Limited, Essex (GB)

(21) Appl. No.: 16/660,804

(22) Filed: Oct. 23, 2019

(51) Int. Cl. C09J 133/06; C09J 11/04; C08F 220/18; C08K 3/32

(52) U.S. Cl. CPC C09J 133/066; C09J 11/04; C08F 220/18; C08K 2003/324; C08F 2800/20; C08F 2220/1825; C08K 3/32

(57) ABSTRACT

The present invention relates to an aqueous polymer dispersion suitable for use as a pressure sensitive adhesive (PSA). The aqueous polymer dispersion may be capable of a high level of performance relative to other aqueous polymer dispersions by achieving an overall balance of adhesive properties, i.e. high tack, high peel strength, and high shear strength. Without limitation, the aqueous polymer dispersion may be used for tapes, tiles, panels, slates, and the like. In addition, the invention relates to a method for making the aqueous polymer dispersion.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

The invention relates to an aqueous polymer dispersion that may be used as a pressure sensitive adhesive (PSA). More specifically, it relates to an aqueous polymer dispersion that may be used as a PSA capable of an overall balance of adhesive properties such as high tack, high peel strength, and high shear strength.

### Background of the Invention

Tack, peel strength, and shear strength are properties by which adhesives, including PSAs, are measured to identify the type of bond created between two surfaces. Tack is a measure of how quickly a bond is formed. For instance, the more force needed to separate two surfaces, after being brought together under pressure, the higher the tack. Adhesives with high tack may form a bond upon contact with a surface under minimal or no time delay. Peel strength is a measure of the force needed to fracture an adhesive bond between materials, wherein one of the materials may be flexible. When measuring peel strength, separation of the materials occurs at an angle from the plane of adhesion with all of the applied force concentrated on the leading edge of the adhesive rather than across the entire bonded area. Bonds formed using adhesives with high peel strength require a high magnitude of force to break, and therefore may be preferable in situations that require permanent bonding. Bonds using adhesives with low peel strength require a low magnitude of force to break and may be better suited for situations that require temporary bonding. Shear strength is the ability of an adhesive bond to resist forces that may be applied in parallel with the plane of adhesion. In other words, shear strength may be considered the holding power of an adhesive. When measuring shear strength, a bonded substrate may be mounted in a vertical orientation with a specific weight attached. The time and the amount of weight it takes for a bonded substrate to break shows the shear strength of an adhesive. Adhesives with high shear strength are less likely to fail under heavy weight or high stress.

Depending on the application, an end user may desire an adhesive with an overall balance of adhesive properties (i.e. an adhesive with high tack, high peel strength, and high shear strength). In particular, a balance of properties may be desirable in an adhesive used to quickly and securely adhere an object to a surface. Without limitation, floor tile application is an example in which an adhesive with balanced properties may be beneficial. During application, floor tiles may require the ability to reposition and to remain bonded for long periods of time. Currently, those skilled in the art understand that these properties (tack, peel, and shear) may be manipulated to desired levels by changing the process parameters of a composition. However, such manipulation may be costly due the number of components that must be added in the process. For instance, one skilled in the art may add a crosslinker or a tackifier to a composition in order to increase the shear strength of an adhesive, but this will typically cause a significant decrease in the peel strength. In general, it is difficult to manipulate the properties in such a way as to increase both the shear and peel strength, while also managing to minimize cost.

Consequently, there is a need in the art for a polymer capable of being used as a PSA with an overall balance of adhesive properties including high tack, high peel strength, and high shear strength that overcomes the problems associated with prior art in which these properties may not be balanced.

### BRIEF SUMMARY OF SOME OF THE INVENTION

These and other needs in the art are addressed in one embodiment by an aqueous polymer dispersion comprising (A) between 0 wt. % to 2.0 wt. % of at least one unsaturated carboxylic acid, (B) between 0 wt. % to 9.0 wt. % of an acetate ester, (C) between 40.0 wt. % to 55.0 wt. % of at least one acrylate monomer, (D) between 0 wt. % to 1.0 wt. % of at least one hydroxyl functional (meth)acrylic monomer, (E) between 0 wt. % to 1.0 wt. % of at least one formulation stabilizer, and a bimodal particle size distribution, wherein the bimodal particle size distribution contributes to an overall balance of adhesive properties in an aqueous polymer dispersion comprising components (A) through (E).

These and other needs in the art are addressed in one embodiment by a method for making an aqueous polymer dispersion comprising polymerizing a set of monomers comprising the components: (A) between 0 wt. % to 2.0 wt. % of at least one unsaturated carboxylic acid, (B) between 0 wt. % to 9.0 wt. % of an acetate ester, (C) between 40.0 wt. % to 55.0 wt. % of at least one acrylate monomer, (D) between 0 wt. % to 1.0 wt. % of at least one hydroxyl functional (meth)acrylic monomer, and (E) between 0 wt. % to 1.0 wt. % of at least one formulation stabilizer, wherein a bimodal particle size distribution contributes to an overall balance of adhesive properties in an aqueous polymer dispersion comprising components (A) through (D).

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1A illustrates a distribution graph for the average particle size of an aqueous polymer dispersion at 50% of the peak area integration;

FIG. 1B illustrates a distribution graph for the average particle size of an aqueous polymer dispersion at 95% of the peak area integration;

FIG. 2A is a scatter plot illustrating the relationship between particle size and shear strength for a bimodal aqueous polymer dispersion;

FIG. 2B is a scatter plot illustrating the relationship between particle size and shear strength for a unimodal aqueous polymer dispersion;

FIG. 3 is a scatter plot illustrating the relationship between cohesion (Shear Strength) and adhesion (Peel Strength×Tack) for an aqueous polymer dispersion at specific glass transition temperatures;

FIG. 4A illustrates a distribution graph for the results of a Peel 24-hour Stainless Steel Test for an embodiment of an aqueous polymer dispersion;

FIG. 4B illustrates a distribution graph for the results of a Loop Tack Stainless Steel Test for an embodiment of an aqueous polymer dispersion; and

FIG. 4C illustrates a distribution graph for the results of a Shear Test for an embodiment of an aqueous polymer dispersion.

### DETAILED DESCRIPTION OF THE INVENTION

The present invention relates to an aqueous polymer dispersion suitable for use as a pressure sensitive adhesive (PSA). The aqueous polymer dispersion may be capable of a high level of performance relative to other aqueous polymer dispersions by achieving an overall balance of adhesive properties, i.e. high tack, high peel strength, and high shear strength. Further, the aqueous polymer dispersion may achieve high levels of water resistance as well as alkaline resistance. Without limitation, the aqueous polymer dispersion may be used for tapes, tiles, panels, slates, and the like. In addition, the invention relates to a method for making the aqueous polymer dispersion.

The aqueous polymer dispersion may be prepared in deionized water as a composition comprising a polymerization product of the following components: (A) at least one unsaturated carboxylic acid, (B) an acetate ester, (C) at least one acrylate monomer, (D) at least one hydroxyl functional (meth)acrylic monomer, and (E) at least one formulation stabilizer. Optionally, the aqueous polymer dispersion may further comprise, (F) at least one free radical initiator, (G) at least one surfactant, and (H) preserving agents and/or biocides.

In embodiments, the aqueous polymer dispersion may comprise (A) at least one unsaturated carboxylic acid monomer. Examples of unsaturated carboxylic acids monomers may comprise, without limitation, unsaturated monocarboxylic acids, such as acrylic acid, methacrylic acid, hydracrylic acid, crotonic acrylic acid, β-carboxyethyl acrylate, vinyl acetic acid, and vinyl lactic acid; unsaturated dicarboxylic acids such as maleic acid, fumaric acid, itaconic acid, and citraconic acid; unsaturated tricarboxylic acid such as aconitic acid; or any combinations thereof. An example of an acrylic acid may be 2-propenoic acid. An example of a vinyl acetic acid may be 3-butenoic acid. An example of vinyl lactic acid may be 2-hydroxy-4-pentenoic acid. In embodiments, the at least one unsaturated carboxylic acid may be acrylic acid. In other embodiments, different acids may substitute the unsaturated carboxylic acid. A suitable substitute for the at least one unsaturated carboxylic acid monomer may be at least one unsaturated sulfonic acid monomer. Examples of unsaturated sulfonic acid monomers may comprise, vinyl sulfonic acid, methane sulfonic acid, p-toluene sulfonic acid, or any combinations thereof. In certain embodiments, the unsaturated carboxylic acid may be replaced by 2-acrylamido-2-methylpropane sulfonic acid (AMPS).

The at least one unsaturated carboxylic acid may be present in an amount of 0 wt. % to 2.0 wt. % wherein the wt. % in each case is based on the total weight of the wet formulation. When present in the aqueous polymer dispersion, the unsaturated carboxylic acid component may be present in the amount of at least 0.2 wt. %, or at least 0.4 wt. %, or at least 0.6 wt. %, or at least 0.8 wt. %, or at least 1.0 wt. %. The unsaturated carboxylic acid component, in further embodiments, may be present in an amount less than or equal to 2.0 wt. %, or less than or equal to 1.8 wt. %, or less than or equal to 1.6 wt. %, or less than or equal to 1.4 wt. %, or less than or equal to 1.2 wt. %, or less than or equal to 1.0 wt. %. The amount of the unsaturated carboxylic acid component may range between any combination of these lower and upper limit values, such as: from 0 wt. % to 2.0 wt. %; or from 0.5 wt. % to 1.5 wt. %; or from 0.5 wt. % to 1.0 wt. %, wherein each case is based on the total weight of the wet formulation of the aqueous polymer dispersion. For example, the amount of the at least one carboxylic acid may be less than 2.0 wt. %, or alternatively between 0.5 wt. % to 1.5 wt. %, or further in the alternative between 0.6 wt. % to 0.7 wt. %.

In embodiments, the aqueous polymer dispersion may comprise (B) an acetate ester. Examples of acetate esters may comprise, without limitation, methyl acetate, ethyl acetate, isopropyl acetate, vinyl acetate, ethylhexyl acetate, or any combinations thereof. Examples of vinyl acetate may be 1-acetoxyethylene, acetic acid ethenyl ester, or acetic acid vinyl ester. In embodiments, the at least one acetate ester may be vinyl acetate.

The acetate ester may be present in an amount of 0 wt. % to 9.0 wt. % wherein the wt. % in each case is based on the total weight of the wet formulation. When present in the aqueous polymer dispersion, the acetate ester component may be present in the amount of at least 0.5 wt. %, or at least 1.0 wt. %, or at least 1.5 wt. %, or at least 2.0 wt. %, or at least 2.5 wt. %, or at least 3.0 wt. %, or at least 3.5 wt. %, or at least 4.0 wt. %. The acetate ester component, in further embodiments, may be present in an amount less than or equal to 9.0 wt. %, or less than or equal to 8.0 wt. %, or less than or equal to 7.0 wt. %, or less than or equal to 6.0 wt. %, or less than or equal to 5.0 wt. %, or less than or equal to 4.0 wt. %. The amount of the acetate ester component may range between any combination of these lower and upper limit values, such as: from 0 wt. % to 9.0 wt. %; or from 1.0 wt. % to 8.5 wt. %; or from 2.0 wt. % to 8.5 wt. %; or from 3.0 wt. % to 8.5 wt. %, wherein each case is based on the total weight of the wet formulation of the aqueous polymer dispersion. For example, the amount of the at least one acetate ester may be less than 9.0 wt. %, or alternatively at least 5.0 wt. %, or further in the alternative between 4.0 wt. % to 6.0 wt. %.

In embodiments, the aqueous polymer dispersion may comprise (C) at least one acrylate monomer. Examples of acrylate monomers may comprise, without limitation, C₁-C₂₀ alkyl acrylates or alkyl methacrylates. The C₁-C₂₀ alkyl acrylates or alkyl methacrylates may comprise, methyl acrylate, methyl methacrylate, ethyl acrylate, ethyl methacrylate, isopropyl acrylate, isopropyl methacrylate, n-butyl acrylate, n-butyl methacrylate, i-butyl acrylate, i-butyl methacrylate, t-butyl acrylate, t-butyl methacrylate, hexyl acrylate, hexyl methacrylate ethylhexyl acrylate, ethylhexyl methacrylate, 3,3 dimethylbutyl methacrylate, lauryl acrylate, or any combinations thereof. Alternatively, the at least one acrylate monomer may comprise 2-ethylhexyl acrylate, cyclohexyl acrylate, 2-hydroxyethyl acrylate, 2-dimethylaminoethyl acrylate, or any combinations thereof. In certain embodiments, the aqueous polymer dispersion may have a first acrylate monomer and a second acrylate monomer. The first acrylate monomer may comprise an ethyl ester of acrylic acid. In embodiments, the ethyl ester may be ethyl acrylate. The second acrylate monomer may comprise an acrylate ester such as butyl acrylate.

The at least one acrylate monomer may be present in an amount of 40.0 wt. % to 55.0 wt. % wherein the wt. % in each case is based on the total weight of the wet formulation. When present in the aqueous polymer dispersion, the at least one acrylate ester component may be present in the amount of at least 40.0 wt. %, or at least 45.0 wt. %, or at least 50.0 wt. %, or at least 55.0 wt. %. The at least one acrylate monomer component, in further embodiments, may be present in an amount less than or equal to 55.0 wt. %, or less than or equal to 50.0 wt. %, or less than or equal to 45.0 wt. %, or less than or equal to 40.0 wt. %. The amount of the at least one acrylate monomer component may range between any combination of these lower and upper limit values, such as: from 40.0 wt. % to 55.0 wt. %; or from 44.0 wt. % to 54.0 wt. %, wherein each case is based on the total weight of the wet formulation of the aqueous polymer dispersion. In embodiments in which the aqueous polymer dispersion has a first and second acrylate monomer, the first acrylate monomer may be present in an amount between 1.0 wt. % to 2.0 wt. %, or alternatively between 1.4 wt. % to 1.6 wt. %, while the second acrylate monomer may be present in an amount between 40.0 wt. % to 55.0 wt. %, or alternatively between 45.0 wt. % to 50.0 wt. %.

In embodiments, the aqueous polymer dispersion may comprise (D) at least one hydroxyl functional (meth)acrylic monomer. Examples of hydroxyl functional (meth)acrylic monomers may comprise, without limitation, Cᵢ-Cₙ hydroxy functional alkyl acrylates or alkyl methacrylates. In embodiments, the Cᵢ-Cₙ hydroxy functional alkyl acrylates or alkyl methacrylates may comprise hydroxyethyl acrylate, hydroxyethyl methacrylate (HEMA), hydroxypropyl acrylate, hydroxypropyl methacrylate, hydroxybutylacrylate, hydroxybutyl(meth)acrylate, hydroxyhexyl acrylate, hydroxylhexyl methacrylate, hydroxyethylhexyl acrylate, hydroxyethylhexyl methacrylate, or any combinations thereof. Other examples of hydroxyl functional (meth)acrylate monomers include acrylic esters prepared from glycidyl esters of C₂-C₁₂ carboxylic acids. In embodiments, the aqueous polymer dispersion may comprise a C₂-C₈ hydroxyalkyl (meth)acrylate such as hydroxyethyl methacrylate (HEMA).

The at least one hydroxyl functional (meth)acrylic monomer may be present in an amount of 0 wt. % to 1.0 wt. % wherein the wt. % in each case is based on the total weight of the wet formulation. When present in the aqueous polymer dispersion, the at least one hydroxyl functional (meth)acrylic monomer component may be present in the amount of at least 0.1 wt. %, or at least 0.2 wt. %, or at least 0.3 wt. %, or at least 0.4 wt. %, or at least 0.5 wt. %. The at least one hydroxyl functional (meth)acrylic monomer component, in further embodiments, may be present in an amount less than or equal to 1.0 wt. %, or less than or equal to 0.9 wt. %, or less than or equal to 0.8 wt. %, or less than or equal to 0.7 wt. %, or less than or equal to 0.6 wt. %, or less than or equal to 0.5 wt. %. The amount of the least one hydroxyl functional (meth)acrylic monomer component may range between any combination of these lower and upper limit values, such as: from 0 wt. % to 1.0 wt. %; or from 0.5 wt. % to 1.0 wt. %; or from 0.6 wt. % to 1.0 wt. %, wherein each case is based on the total weight of the wet formulation of the aqueous polymer dispersion. For example, the amount of the at least one hydroxyl functional (meth)acrylic monomer may be less than 1.0 wt. %, or alternatively between 0.5 wt. % to 1.0 wt. %, or further in the alternative between 0.5 wt. % to 0.7 wt. %.

In embodiments, the aqueous polymer dispersion may comprise (E) at least one formulation stabilizer. Examples of formulation stabilizers may comprise, without limitation, Tris(2,4-di-tert-butylphenyl)phosphite, butylated hydroxytoluene, tripotassium phosphate, monomers from the sipomer series, or any combinations thereof. In certain embodiments, the aqueous polymer dispersion may have two formulation stabilizers. The first formulation stabilizer may comprise tripotassium phosphate, and the second formulation stabilizer may comprise a monomer from the sipomer series (e.g. Sipomer® B-CEA, commercially available). Alternatively, these stabilizers may be selected from any other stabilizing monomer commonly used in the art.

The at least one formulation stabilizer may be present in an amount of 0 wt. % to 1.0 wt. % wherein the wt. % in each case is based on the total weight of the wet formulation. When present in the aqueous polymer dispersion, the at least one formulation stabilizer component may be present in the amount of at least 0.05 wt. %, or at least 0.1 wt. %, or at least 0.2 wt. %, or at least 0.3 wt. %, or at least 0.4 wt. %, or at least 0.5 wt. %. The at least one formulation stabilizer component, in further embodiments, may be present in an amount less than or equal to 1.0 wt. %, or less than or equal to 0.5 wt. %, or less than or equal to 0.3 wt. %, or less than or equal to 0.1 wt. %, or less than or equal to 0.05 wt. %. The amount of the at least one formulation stabilizer component may range between any combination of these lower and upper limit values, such as: from 0 wt. % to 1.0 wt. %; or from 0 wt. % to 0.5 wt. %; or from 0 wt. % to 0.1 wt. %, wherein each case is based on the total weight of the wet formulation of the aqueous polymer dispersion. In embodiments in which the aqueous polymer dispersion has a first and a second formulation stabilizer, the first formulation stabilizer may be present in an amount between 0 wt. % to 0.1 wt. %, or alternatively between 0.05 wt. % to 0.1 wt. %, the second formulation stabilizer may be present in an amount between 0 wt. % to 0.5 wt. %, or alternatively between 0 wt. % to 0.3 wt. %.

In embodiments, the aqueous polymer dispersion may comprise (F) at least one free radical initiator. Examples of free radical initiators may comprise, without limitation, azo compounds, inorganic peroxy compounds, organic peroxy compounds, persulfates, peroxides, esters, or any combinations thereof. The azo compounds may include, without limitation, azobisisobutyronitrile (AIBN), 2,2′-azobis(2-methylpropionitrile) (AMBN), and cyanovaleric acid. The inorganic peroxy compounds may include, without limitation, hydrogen peroxide, sodium, potassium and ammonium peroxydisulfate, peroxycarbonates, and peroxyborates. The organic peroxy compounds may include, without limitation, alkyl hydroperoxides, dialkyl peroxides, acyl hydroperoxides, and diacyl peroxides. The esters may include, without limitation, tertiary butyl perbenzoate, and combinations of inorganic and organic initiators. In certain embodiments, the free radical initiators may comprise sodium formaldehyde sulfoxylate, sodium persulfate, sodium metabisulfite (SMBS), ascorbic acid, ferrous salts, chelated iron salts, and the like. Additionally, in embodiments, the at least one free radical initiator may be an oxidizer such as tert-Butyl hydroperoxide, cumyl hydroperoxide, tamyl hydroperoxide, or any combinations thereof. The oxidizer may be a redox reagent used to generate radical flux. In embodiment, the aqueous polymer dispersion may comprise a first, second, and third free radical initiator. In one embodiment, the first free radical initiator may comprise sodium persulfate, the second free radical initiator may comprise tert-Butyl hydroperoxide (may be supplied as a 70% aqueous solution), and the third free radical initiator may comprise SMBS.

The at least one free radical initiator may be present in an amount of 0 wt. % to 2.0 wt. % wherein the wt. % in each case is based on the total weight of the wet formulation. When present in the aqueous polymer dispersion, the at least one free radical initiator component may be present in the amount of at least 0.1 wt. %, or at least 0.2 wt. %, or at least 0.3 wt. %, or at least 0.4 wt. %, or at least 0.5 wt. %. The at least one free radical initiator component, in further embodiments, may be present in an amount less than or equal to 2.0 wt. %, or less than or equal to 1.0 wt. %, or less than or equal to 0.9 wt. %, or less than or equal to 0.8 wt. %, or less than or equal to 0.7 wt. %, or less than or equal to 0.6 wt. %, or less than or equal to 0.5 wt. %. The amount of the at least one free radical initiator component may range between any combination of these lower and upper limit values, such as: from 0 wt. % to 2.0 wt. %; or from 0.5 wt. % to 1.0 wt. %; or from 0.6 wt. % to 1.0 wt. %, wherein each case is based on the total weight of the wet formulation of the aqueous polymer dispersion. In embodiments in which the aqueous polymer dispersion has a first, second, and third free radical initiator, the first free radical initiator may be present in an amount between 0 wt. % to 1.0 wt. %, or alternatively between 0.6 wt. % to 0.8 wt. %, the second free radical initiator may be present in an amount between 0 wt. % to 0.5 wt. %, or alternatively between 0.1 wt. % to 0.2 wt. %, and the third free radical initiator may be present in an amount between 0 wt. % to 0.5 wt. %, or alternatively between 0.1 wt. % to 0.2 wt. %.

In embodiments, the aqueous polymer dispersion may comprise (G) at least one surfactant. The at least one surfactant may be a reactive anionic surfactant, nonionic surfactant, cationic surfactant, or any combinations thereof. Examples of anionic surfactants include, but are not limited to, alkyl sulfates, sulfates of ethoxylate alcohols, aryl sulfonates, phosphates of ethoxylated alcohols, sulfosuccinates, sulfates and sulfonates of ethoxylated alkylphenols, and mixtures thereof. Examples of nonionic surfactants include, but are not limited to, ethoxylated alcohols, ethoxylated alkylphenols, and mixtures thereof. Examples of cationic surfactants include, but are not limited to, ethoxylated fatty amines. In embodiments, the at least one surfactant may be selected from the Adeka SR series, the Adeka ER series, the Abex series, the Hitenol series, or any combinations thereof (commercially available). In embodiments, the at least one surfactant of the aqueous polymer dispersion may comprise a reactive surfactant and a nonionic surfactant. The reactive surfactant may be from the Adeka series, and the nonionic surfactant may be from the Abex series. Alternatively, these surfactants may be selected from any other stabilizing surfactants commonly used in the art. In further embodiments, the aqueous polymer dispersion may further comprise an additional surfactant such as a post-add surfactant. The post-add surfactant that may be any surfactant capable of ensuring good coat quality as well as good film formation in the aqueous polymer dispersion. Additionally, the post-add surfactant may be any surfactant needed to convert the aqueous polymer dispersion into a coater ready package which may allow for the aqueous polymer dispersion to be converted into an adhesive tape. The post-add surfactant may be selected from any of the surfactants previously described herein.

The at least one surfactant may be present in an amount of 0 wt. % to 5.0 wt. % wherein the wt. % in each case is based on the total weight of the wet formulation. When present in the aqueous polymer dispersion, the at least one surfactant component may be present in the amount of at least 0.5 wt. %, or at least 1.0 wt. %, or at least 2.0 wt. %, or at least 3.0 wt. %, or at least 4.0 wt. %. The at least one surfactant component, in further embodiments, may be present in an amount less than or equal to 5.0 wt. %, or less than or equal to 4.0 wt. %, or less than or equal to 3.0 wt. %, or less than or equal to 2.0 wt. %, or less than or equal to 1.0 wt. %, or less than or equal to 0.5 wt. %. The amount of the at least one surfactant component may range between any combination of these lower and upper limit values, such as: from 0 wt. % to 5.0 wt. %; or from 0.5 wt. % to 4.0 wt. %; or from 1.0 wt. % to 4.0 wt. %; or from 2.0 wt. % to 4.0 wt. %, wherein each case is based on the total weight of the wet formulation of the aqueous polymer dispersion. In embodiments in which the aqueous polymer dispersion has a reactive and nonionic surfactant, the reactive surfactant may be present in an amount between 0 wt. % to 4.0 wt. %, or alternatively between 3.0 wt. % to 4.0 wt. %, while the nonionic surfactant may be present in an amount between 0 wt. % to 0.5 wt. %, or alternatively between 0.2 wt. % to 0.3 wt. %.

In embodiments, the aqueous polymer dispersion may be optionally protected by (H) preserving agents and/or biocides. Examples of the preserving agents and/or biocides may comprise the anticide series, isothiazolinone (CIT), benzisothiazolinone (BIT), methylisothiazolinone (MIT), bronopol, or any combinations thereof. In one embodiment, the preserving agent and/or biocide may be selected from the anticide series (commercially available).

The preserving agent and/or biocide may be present in an amount of 0 wt. % to 1.0 wt. % wherein the wt. % in each case is based on the total weight of the wet formulation. When present in the aqueous polymer dispersion, the preserving agent and/or biocide component may be present in the amount of at least 0.05 wt. %, or at least 0.1 wt. %, or at least 0.2 wt. %, or at least 0.3 wt. %, or at least 0.4 wt. %, or at least 0.5 wt. %. The preserving agent and/or biocide component, in further embodiments, may be present in an amount less than or equal to 1.0 wt. %, or less than or equal to 0.7 wt. %, or less than or equal to 0.5 wt. %, or less than or equal to 0.3 wt. %, or less than or equal to 0.1 wt. %, or less than or equal to 0.05 wt. %. The amount of the preserving agent and/or biocide component may range between any combination of these lower and upper limit values, such as: from 0 wt. % to 1.0 wt. %; or from 0 wt. % to 0.5 wt. %; or from 0 wt. % to 0.1 wt. %, wherein each case is based on the total weight of the wet formulation of the aqueous polymer dispersion. For example, the amount of the preserving agent and/or biocide may be less than 1.0 wt. %, or alternatively between 0 wt. % to 0.1 wt. %, or further in the alternative between 0 wt. % to 0.05 wt. %.

In accordance with the present invention, there is provided a method for making the composition of the aqueous polymer dispersion. The method for making this polymerization product may comprise, polymerizing a set of monomers in deionized water. The set of monomers may comprise the components (A) through (E) as described herein, and optionally at least one of the components (F) through (H), as described herein. Further, the set of monomers may comprise one or more additives in addition to the components (A) through (H).

The polymerization product of the aqueous polymer dispersion may be prepared in accordance with art-recognized polymerization methods. According to a further embodiment, there may be provided a process for the preparing of the aqueous polymer dispersion comprising the free-radical aqueous emulsion polymerization of the ethylenically unsaturated monomers M of which the polymer is composed by a monomer feed process, at least 95% of the monomers to be polymerized being added under polymerization conditions to a first.

Further, the process of developing the aqueous polymer dispersion may comprise a chase package. The chase package may leave the aqueous polymer dispersion in a semi-converted state so as to generate oligomers in situ during a chase. This formed oligomer content prevents the need for a tackifier for the aqueous polymer dispersion. Additionally, the process may allow for tack to remain high while the VOC and the grit are low, even after the chase. This specific combination of ingredients may produce an unexpectedly improved balance of adhesive properties and may raise performance to an unexpectedly high level of performance relative to the combination of ingredients.

In embodiments, the deionized water may be present in an amount of 0 wt. % to 40.0 wt. % wherein the wt. % in each case is based on the total weight of the wet formulation. When present in the aqueous polymer dispersion, the deionized water component may be present in the amount of at least 1.0 wt. %, or at least 5.0 wt. %, or at least 10 wt. %, or at least 20 wt. %, or at least 30 wt. %. The deionized water component, in further embodiments, may be present in an amount less than or equal to 40.0 wt. %, or less than or equal to 35.0 wt. %, or less than or equal to 30.0 wt. %, or less than or equal to 20.0 wt. %, or less than or equal to 15.0 wt. %, or less than or equal to 10.0 wt. %. The amount of the deionized water component may range between any combination of these lower and upper limit values, such as: from 0 wt. % to 40.0 wt. %; or from 20.0 wt. % to 40.0 wt. %; or from 30.0 wt. % to 40.0 wt. %, wherein each case is based on the total weight of the wet formulation of the aqueous polymer dispersion. For example, the amount of the deionized water may be less than 40.0 wt. %, or alternatively between 30.0 wt. % to 40.0 wt. %, or further in the alternative between 33.0 wt. % to 36.0 wt. %.

The aqueous polymer dispersion may further comprise one or more additives comprising at least one of a tackifier, an antifoam, a plasticizer, a wetting agent, a protective colloid, filler, a coloring agent, an antiseptic, an additional biocide, a dispersing agent, a thickening agent, a thixotropic agent, an antifreeze agent, a pH adjusting agent, a corrosion inhibitor, an ultraviolet light stabilizer, a crosslinking promoter, an antioxidant, a chain transferring agent, another polymer, or any combinations thereof. Each additive may be individually present in an amount from 0.05 wt. % to 20 wt. %, or alternatively from 0.05 wt. % to 10 wt. %, or further in the alternative from 0.05 wt. % to 5 wt. %.

In embodiments, the pH adjusting agent may be ammonia supplied as a 30% aqueous solution. The pH adjusting agent may be present in an amount of 0 wt. % to 1.0 wt. % wherein the wt. % in each case is based on the total weight of the wet formulation. When present in the aqueous polymer dispersion, the pH adjusting agent component may be present in the amount of at least 0.1 wt. %, or at least 0.2 wt. %, or at least 0.3 wt. %, or at least 0.4 wt. %, or at least 0.5 wt. %. The pH adjusting agent component, in further embodiments, may be present in an amount less than or equal to 1.0 wt. %, or less than or equal to 0.5 wt. %, or less than or equal to 0.4 wt. %, or less than or equal to. 0.3 wt. %, or less than or equal to 0.2 wt. %, or less than or equal to 0.1 wt. %. The amount of the pH adjusting agent component may range between any combination of these lower and upper limit values, such as: from 0 wt. % to 1.0 wt. %; or from 0.2 wt. % to 0.5 wt. %; or from 0.4 wt. % to 0.5 wt. %, wherein each case is based on the total weight of the wet formulation of the aqueous polymer dispersion. For example, the amount of the pH adjusting agent may be less than 1.0 wt. %, or alternatively between 0.4 wt. % to 1.0 wt. %, or further in the alternative between 0.4 wt. % to 0.5 wt. %.

In embodiments, the aqueous polymer dispersion may comprise a chain transferring agent. Chain transfer agents are commonly employed in free radical polymerizations or emulsion polymerization to control molecular weight or tack. In certain embodiments, the chain transferring agent may be n-Dodecyl Mercaptan (n-DDM). The n-DDM may be present in an amount of 0 wt. % to 0.2 wt. % wherein the wt. % in each case is based on the total weight of the wet formulation. When present in the aqueous polymer dispersion, the n-DDM component may be present in the amount of at least 0.05 wt. %, or at least 0.1 wt. %, or at least 0.15 wt. %, or at least 0.2 wt. %. The n-DDM component, in further embodiments, may be present in an amount less than or equal to 0.2 wt. %, or less than or equal to 0.15 wt. %, or less than or equal to 0.1 wt. %, or less than or equal to 0.05 wt. %. The amount of the n-DDM component may range between any combination of these lower and upper limit values, such as: from 0 wt. % to 0.2 wt. %; or from 0 wt. % to 0.1 wt. %; or from 0 wt. % to 0.05 wt. %, wherein each case is based on the total weight of the wet formulation of the aqueous polymer dispersion. For example, the amount of the n-DDM may be less than 0.2 wt. %, or alternatively between 0.05 wt. % to 0.1 wt. %, or further in the alternative between 0.05 wt. % to 0.08 wt. %.

In further embodiments, the aqueous polymer dispersion may be formed from seeds or emulsion polymers with predetermined sizes. Seeds may be used to initiate free radical polymerizations or emulsion polymerizations. In embodiments, the aqueous polymer dispersion may comprise a first and second acrylic seed. The first acrylic seed may be an acrylic copolymer seed with an average diameter of 150 nanometer (nm), and the second acrylic seed may be another different acrylic copolymer seed with an average diameter of 40 nm, or combinations thereof.

The first acrylic seed may be present in an amount of 0 wt. % to 1.0 wt. % wherein the wt. % in each case is based on the total weight of the wet formulation. When present in the aqueous polymer dispersion, the first acrylic seed component may be present in the amount of at least 0.05 wt. %, or at least 0.1 wt. %, or at least 0.2 wt. %, or at least 0.3 wt. %, or at least 0.4 wt. %, or at least 0.5 wt. %. The first acrylic seed component, in further embodiments, may be present in an amount less than or equal to 1.0 wt. %, or less than or equal to 0.7 wt. %, or less than or equal to 0.5 wt. %, or less than or equal to 0.3 wt. %, or less than or equal to 0.1 wt. %, or less than or equal to 0.05 wt. %. The amount of the first acrylic seed component may range between any combination of these lower and upper limit values, such as: from 0 wt. % to 1.0 wt. %; or from 0 wt. % to 0.5 wt. %; or from 0 wt. % to 0.3 wt. %, wherein each case is based on the total weight of the wet formulation of the aqueous polymer dispersion. For example, the amount of the first acrylic seed may be less than 1.0 wt. %, or alternatively between 0 wt. % to 0.5 wt. %, or further in the alternative between 0.2 wt. % to 0.3 wt. %. The second acrylic seed may also be present in an amount of 0 wt. % to 1.0 wt. % wherein the wt. % in each case is based on the total weight of the wet formulation. When present in the aqueous polymer dispersion, the second acrylic seed component may be present in the amount of at least 0.1 wt. %, or at least 0.2 wt. %, or at least 0.3 wt. %, or at least 0.4 wt. %, or at least 0.5 wt. %, or at least 0.6 wt. %. The second acrylic seed component, in further embodiments, may be present in an amount less than or equal to 1.0 wt. %, or less than or equal to 0.7 wt. %, or less than or equal to 0.5 wt. %, or less than or equal to 0.3 wt. %, or less than or equal to 0.1 wt. %, or less than or equal to 0.05 wt. %. The amount of the second acrylic seed component may range between any combination of these lower and upper limit values, such as: from 0 wt. % to 1.0 wt. %; or from 0 wt. % to 0.7 wt. %; or from 0.5 wt. % to 0.7 wt. %, wherein each case is based on the total weight of the wet formulation of the aqueous polymer dispersion. For example, the amount of the second acrylic seed may be less than 1.0 wt. %, or alternatively between 0 wt. % to 0.7 wt. %, or further in the alternative between 0.5 wt. % to 0.6 wt. %.

In embodiments, the first and second acrylic seeds may contribute to a polymodal particle size distribution in the aqueous polymer dispersion. By making the aqueous polymer dispersion bimodal, an unexpectedly improved balance of adhesive properties relative to the specific combination of ingredients may be achieved. In other words, a change in the particle size distribution from unimodal to bimodal of the aqueous polymer dispersion comprising the aforementioned ingredients at each particular amount may result in an aqueous polymer dispersion with high tack, high peel, and high shear strength. High tack may be considered by one skilled in the art, without limitation, greater than or equal to 2 lbs. High peel strength may be considered by those skilled in the art, without limitation, greater than or equal to 3 lbs/in. High shear strength may be considered by one skilled in the art greater than or equal to 200 minutes on a 0.5×0.5×500 g based on PSTC test methods on stainless steel. This overall balance of adhesive properties may not occur for aqueous polymer dispersions of different ingredients and/or with the same ingredients at different amounts.

In embodiments, the polymodal size distribution may be bimodal and evaluated using a volume distribution. Measured with a light scattering method, embodiments of the aqueous polymer dispersion may comprise a first set of particles with an average particle size (based on diameter) between 300 and 400 nm at the 50% peak area integration and a second set of particles with an average particle size between 900 and 1050 nm at the 95% peak area integration. In an alternative embodiment, the first set of particles may have an average particle size between 320 and 395 nm at the 50% peak area integration and the second set of particles may have an average particle size between 920 and 1035 nm at the 95% peak area integration. In yet another alternative embodiment, the first set of particles may have an average particle size between 326 and 387 nm at the 50% peak area integration and the second set of particles may have an average particle size between 930 and 1029 nm at the 95% peak area integration. The first set of particles may be considered as fine or small particles, while the second set of particles may be considered as large particles.

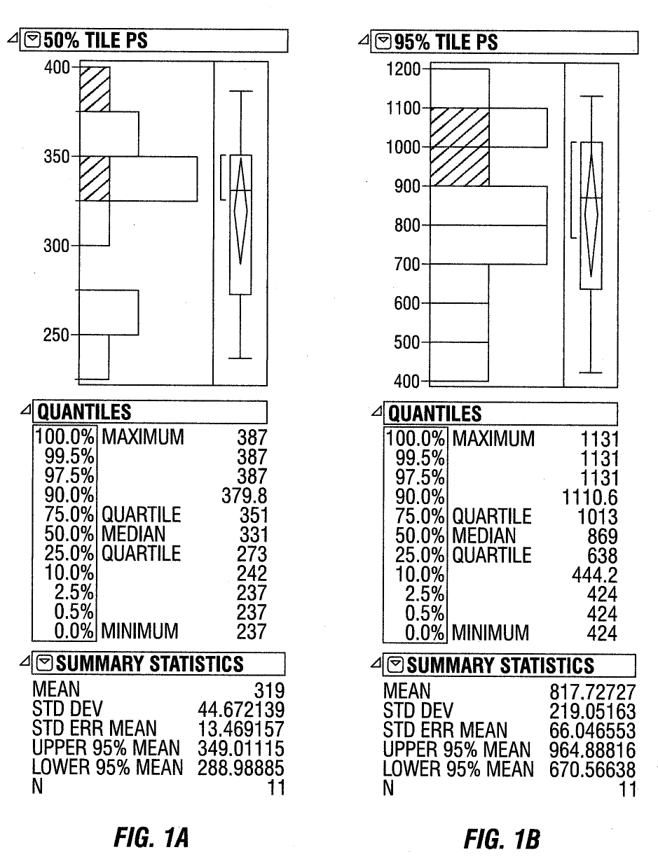

FIGS. 1A and 1B illustrate a particular embodiment of the aqueous polymer dispersion. This embodiment has a bimodal particle size distribution comprising a first and second mode. FIG. 1A illustrates a bar graph of the first mode occurring in the 50% peak area integration displaying the various particle sizes measured using the light scattering method. FIG. 1B illustrates a bar graph of the second mode occurring in the 95% peak area integration displaying the various particle sizes measured using the same method. The bar graphs of FIGS. 1A and 1B, along with the quantiles and summary statistics tables, illustrate a particle size distribution which may correspond to the aforementioned average particle sizes of the first and second set of particles.

As previously described herein, and further illustrated in FIGS. 1A and 1B, the aqueous polymer dispersion may comprise both small and large particles. In embodiments, the small particles may comprise 60% or more of the total volume of particles. Alternatively, the small particles may comprise 70% or more of the total volume of particles. Further in the alternative, the small particles may comprise 80% or more of the total volume of particles.

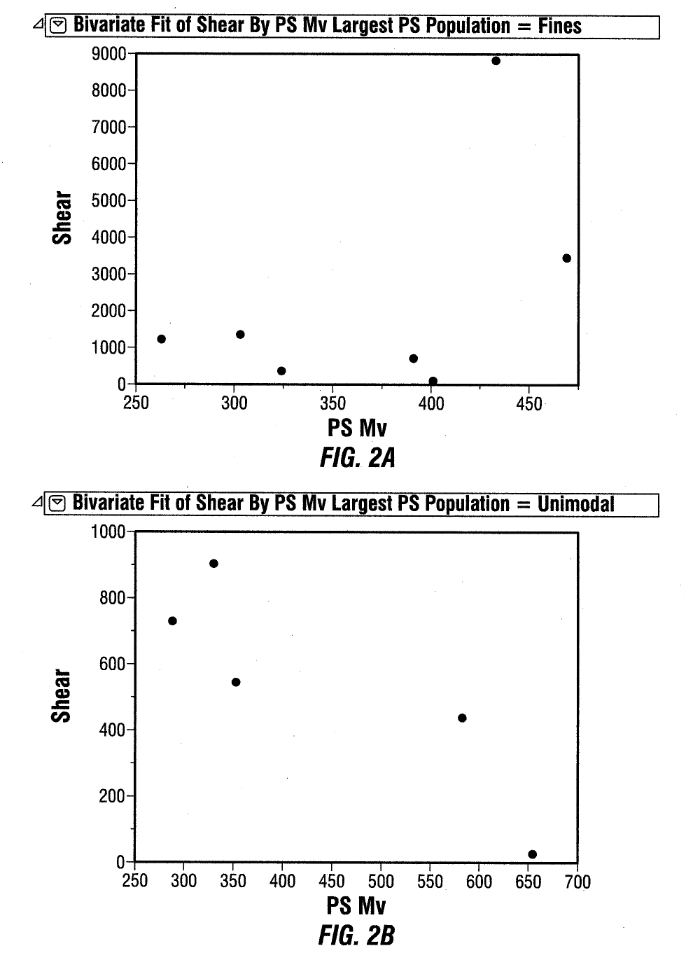

In embodiments the aqueous polymer dispersion may be manipulated to comprise a bimodal particle size distribution, as previously described herein, in order to contribute to shorter cycle times and improved film formation. Additionally, the aqueous polymer dispersion with a bimodal particle size distribution may comprise, without limitation, characteristics such as high solids, low viscosity, and sprayability. In further embodiments, the bimodal particle size distribution unexpectedly contributes to the overall balance of adhesive properties for the particular aqueous polymer dispersion previously described herein. FIGS. 2A and 2B illustrate the affect a bimodal particle size distribution may have on shear strength of this aqueous polymer dispersion. FIG. 2A illustrates the relationship between the average particle size (mean volume) of this aqueous polymer dispersion and its shear strength. In this example, the aqueous polymer dispersion has a bimodal distribution in which a majority of the particle population is small. As the size of the small particles increases, the shear strength also increases. This is not the case for an aqueous polymer dispersion with a unimodal distribution. FIG. 2B illustrates an example of an aqueous polymer dispersion with a unimodal distribution. In this situation the shear strength decreases as the particle size increases. In comparing FIGS. 2A and 2B, one skilled in the art may understand the significance a bimodal particle size distribution has on shear strength of this aqueous polymer dispersion.

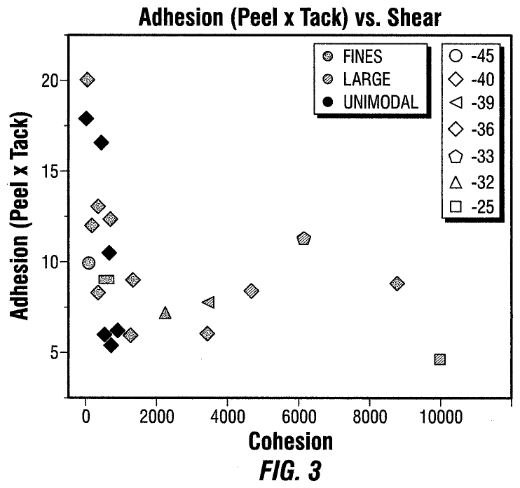

In embodiments, the aqueous polymer dispersion may have a glass transition temperature (T_{g}) of between about −45 and −20° C. Alternatively, the T_{g} of the aqueous polymer dispersion may be about −36° C. FIG. 3 illustrates a scatter plot of the relationship between cohesion (Shear Strength) and adhesion (Peel Strength×Tack) for the aqueous polymer dispersion at specific glass transition temperatures. Further, the graph illustrates the particle size distribution at each plot point (fine, large, and unimodal). Fine denotes a bimodal particle size distribution in which a majority of the particles are small in size, large denotes a bimodal particle size distribution in which a majority of the particles are large in size, and unimodal denotes a unimodal size distribution. One of ordinary skill in the art may recognize, based on FIG. 3, that the greatest balance of properties occurs when the aqueous polymer dispersion has a bimodal particle size distribution with a majority of small particles at a T_{g} of −36° C.

To further illustrate the present invention, the following example and comparative examples are provided. Example 1 shows an embodiment of the aqueous polymer dispersion in which an overall balance of adhesive properties was obtained. The comparative examples show embodiments with various differences from that of Example 1 and the effect these differences have on the resulting adhesive properties. These examples are intended to be illustrative only since the modifications and variations therein will be apparent to one skilled in the art.

### EXAMPLES

The following abbreviations are used in the examples. Note that instances in which the results are omitted from the tables is intentional and does not take away from the demonstration of the examples.

### W Deionized Water

### ASI Acrylic Seed I

### ASII Acrylic Seed II

### NAPS Sodium Persulfate

### ABEX Abex Surfactant

### ADEKA Adeka Sufactant

### TPP Tripotassium Phosphate

### B-CEA Sipomer B-CEA

### AA Acrylic Acid

### VA Vinyl Acrylate

### HEMA (Hydroxyethyl)methacrylate

### EA Ethyl Acrylate

### BA Butyl Acrylate

### TBHP Tert-Butyl Hydroperoxide (70%)

### SMBS Sodium Metabisulfate

### AMM Ammonium (30%)

### CBM2 Acticide CBM2

### MMA Methyl Methacrylate

### pH pH Level

### SP Solids Percentage

### Visc Viscosity

### RCM Residual Monomer Content

### 50 PS 50 Percentile Particle Size

### 95 PS 95 Percentile Particle Size

### Mᵥ PS Mean Volume Particle Size

### Mₙ PS Mean Number Particle Size

### PDI Polydispersity Index

### LPSP Largest Particle Size Population

### PSR Particle Size Ratio

### OPSD Observed Particle Size Distribution

### T_{g} Glass Transition Temperature

### Uni Unimodal

### Bi Bimodal

### PL 15M (SS) Peel 15 Minute (SS)

### PL 1H (SS) Peel 1 Hour (SS)

### PL 24H (SS) Peel 24 Hours (SS)

### PL 15M (G) Peel 15 Minute (G)

### PL 1H (G) Peel 1 Hour (G)

### PL 24H (G) Peel 24 Hour (G)

### LT (SS) Loop Tack (SS)

### LT (G) Loop Tack (G)

### Shear Shear (SS)

PL IM 1H (SS) Peel after Immersion, 1 Hour (SS)
PL IM 24H (SS) Peel after Immersion, 24 Hour (SS)
IM DEL Immersion Delta in water
PL KOH IM 1H (SS) Peel after Immersion in KOH Solution, 1 Hour (SS)
PL KOH IM 24H (SS) Peel after Immersion in KOH Solution, 24 Hour (SS)
KOH IM DEL Immersion Delta in KOH solution

### Haze 1H Haze 1 Hour

### Haze 24H Haze 24 Hour

### DINP Diisononyl Phthalate Drop Test

### Example 1

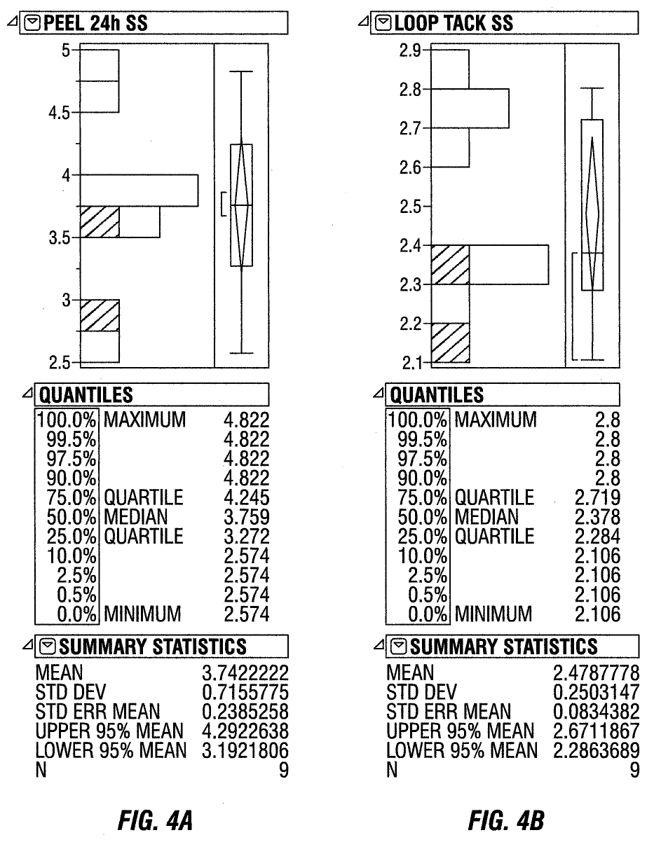

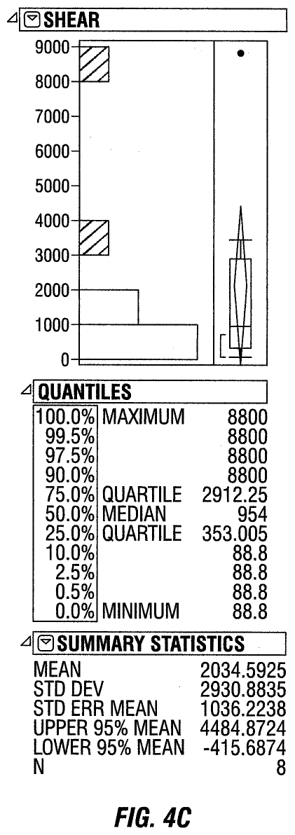

An embodiment of the aqueous polymer dispersion was made by polymerizing the components listed in Table 1 at the specified amounts. The amount of each component is based on a wet in wet volume for a total of 100%. The resulting adhesive properties for this embodiment of the aqueous polymer dispersion are displayed in Table 2 (FIGS. 4A-4C illustrate more extensive measurements of these results). Once produced, a series of tests were performed on this particular embodiment of the aqueous polymer dispersion, results of which are shown in Table 3. The tests performed on this embodiment of the aqueous polymer dispersion are that of standard adhesive tests known to those skilled in the art. The tests included a 15 minute, 1 hour, and 24 hour peel test on stainless steel (SS) and glass (G); a loop tack test on stainless steel and glass; a shear strength test on stainless steel; a 1 hour and 24 hour peel test on stainless steel after full immersion; a 1 hour and 24 hour peel test on stainless steel after immersion in a KOH solution; a 1 hour and 24 hour haze test; and a Diisononyl Phthalate (DINP) Drop Test.

TABLE 1
Components for an Embodiment of
the Aqueous Polymer Dispersion

| Component | Amount (wt. %) |
|---|---|
| Deionized Water | 35.824 |
| Acrylic Seed I | 0.262 |
| Acrylic Seed II | 0.524 |
| Sodium Persulfate | 0.681 |
| Abex Surfactant | 0.275 |
| Adeka Sufactant | 3.273 |
| Tripotassium Phosphate | 0.081 |
| Sipomer B-CEA | 0.275 |
| Acrylic Acid | 0.784 |
| Vinyl Acrylate | 5.816 |
| (Hydroxyethyl)methacrylate | 0.602 |
| Ethyl Acrylate | 1.425 |
| Butyl Acrylate | 49.399 |
| Tert-Butyl Hydroperoxide (70%) | 0.128 |
| Sodium Metabisulfate | 0.128 |
| Ammonium (30%) | 0.471 |
| Acticide CBM2 | 0.052 |

TABLE 2
Resulting Characteristics of an Embodiment
of the Aqueous Polymer Dispersion

| Parameter | Result |
|---|---|
| pH Level | 5.67 |
| Solids Percentage | 59.75 |
| Viscosity (Brookfield, Sp3, 20 rpm, Centpoise) | 145 |
| Grit | 0 |
| Residual Monomer Content (ppm) | 1576 |
| 50 Percentile Particle Size (Diameter, in nanometers) | 326 |
| 95 Percentile Particle Size (Diameter, in nanometers) | 930 |
| Mean Volume Particle Size (Diameter, in nanometers) | 433 |
| Mean Number Particle Size (Diameter, in nanometers) | 241 |
| Polydispersity Index | 1.8 |
| Largest Particle Size Population | Small |
| Particle Size Ratio (Small:Large) | 74:26 |
| Observed Particle Size Distribution | Bimodal |
| Glass Transition Temperature (° C.) | −36 |

TABLE 3
Standard Testing Results for an Embodiment
of the Aqueous Polymer Dispersion

| Test | Result |
|---|---|
| Peel 15 Minute (lbs/inch) (SS) | 2.175 |
| Peel 1 Hour (lbs/inch) (SS) | 2.86 |
| Peel 24 Hours (lbs/inch) (SS) | 3.719 |
| Peel 15 Minute (lbs/inch) (G) | 2.362 |
| Peel 1 Hour (lbs/inch) (G) | 2.474 |
| Peel 24 Hour (lbs/inch) (G) | 3.344 |
| Loop Tack (lbs) (SS) | 2.278 |
| Loop Tack (lbs) (G) | 2.246 |
| Shear (in minutes) (SS) (0.5 × 0.5 × 500 g) | 8800.00 |
| Peel after Immersion, 1 Hour (lbs/inch) (SS) | 3.318 |
| Peel after Immersion, 24 Hour (lbs/inch) (SS) | 3.365 |
| Peel after Immersion in KOH Solution, 1 Hour (lbs/inch) (SS) | 3.444 |
| Peel after Immersion in KOH Solution, 24 Hour (lbs/inch) | 3.825 |
| (SS) | |
| Haze 1 Hour (%) | 4.3 |
| Haze 24 Hour (%) | 17.9 |
| Diisononyl Phthalate Drop Test | Pass |
| (Pass - no blisters/Fail - blisters) | |

The polymerization product of the aforementioned components raised the adhesive performance of the aqueous polymer dispersion to unexpectedly high levels, resulting in an overall balance of adhesive properties. The aqueous polymer dispersion which may be capable of being used as a PSA, resulted in at least one of a 180° peel as measured by ASTM 3330 on stainless steel at room temperature with 15 minute dwell from about 315 Newtons/meter (N/m) (1.8 lbs/in) to about 385 N/m (2.2 lbs/in), a 180° peel as measured by ASTM 3330 on stainless steel with 24 hour dwell at room temperature from about 420 N/m (2.4 lbs/in) to about 647 N/m (3.7 lbs/in), and/or a shear holding strength as measured by ASTM D3654 of from 540 minutes to about 8800 minutes.

### Comparative Examples 2-9

Examples 2-9 were each produced and tested as described in Example 1. However, Examples 2-9 are each different embodiments of the aqueous polymer dispersion in which various components and/or aspects of the composition were changed. The amount used in the polymerization for each component in Examples 2-9 are shown in Table 4. The amount of each component is based on a wet in wet volume for a total of 100%. The resulting adhesive properties are shown for comparison in Table 5. Further, results for each standard test are shown for comparison in Table 6.

TABLE 4
Components Amounts - Comparison for Embodiments
of the Aqueous Polymer Dispersion

| | EX. 1 | EX. 2 | EX. 3 | EX. 4 | EX. 5 | EX. 6 | EX. 7 | EX. 8 | EX. 9 |
|---|---|---|---|---|---|---|---|---|---|
| W | 35.824 | 33.104 | 35.853 | 35.853 | 35.824 | 35.82 | 35.824 | 35.824 | 35.824 |
| ASI | 0.262 | 0 | 0.263 | 0.262 | 0.262 | 0.26 | 0.262 | 0.262 | 0.262 |
| ASII | 0.524 | 3.167 | 0.525 | 0.524 | 0.524 | 0.52 | 0.524 | 0.524 | 0.524 |
| NAPS | 0.681 | 0.686 | 0.683 | 0.681 | 0.681 | 0.68 | 0.681 | 0.681 | 0.681 |
| ABEX | 0.275 | 0.277 | 0.276 | 0.275 | 0.273 | 0.27 | 0.275 | 0.275 | 0.275 |
| ADEKA | 3.273 | 3.035 | 3.282 | 3.276 | 3.273 | 3.27 | 3.273 | 3.273 | 3.273 |
| TPP | 0.081 | 0.082 | 0.081 | 0 | 0.081 | 0.08 | 0.081 | 0.081 | 0.081 |
| B-CEA | 0.275 | 0.277 | 0 | 0.275 | 0.274 | 0.27 | 0.275 | 0.275 | 0.275 |
| AA | 0.784 | 0.790 | 0.786 | 0.784 | 0.784 | 0.78 | 0.784 | 0.784 | 0.784 |
| VA | 5.816 | 5.862 | 5.832 | 5.821 | 3.197 | 5.82 | 8.435 | 4.507 | 5.816 |
| HEMA | 0.602 | 0.607 | 0.604 | 0.603 | 0.602 | 0.60 | 0.602 | 0.602 | 0.602 |
| EA | 1.425 | 1.436 | 1.428 | 1.426 | 1.425 | 1.42 | 1.425 | 1.425 | 1.425 |
| BA | 49.399 | 49.790 | 49.535 | 49.439 | 52.017 | 46.78 | 46.780 | 50.708 | 42.852 |
| TBHP | 0.128 | 0.129 | 0.129 | 0.128 | 0.128 | 0.13 | 0.128 | 0.128 | 0.128 |
| SMBS | 0.128 | 0.129 | 0.129 | 0.128 | 0.128 | 0.13 | 0.128 | 0.128 | 0.128 |
| AMM | 0.471 | 0.475 | 0.473 | 0.471 | 0.471 | 0.47 | 0.471 | 0.471 | 0.471 |
| CBM2 | 0.052 | 0.053 | 0.053 | 0.052 | 0.052 | 0.05 | 0.052 | 0.052 | 0.052 |
| MMA | | | | | | 2.62 | | | 6.547 |

TABLE 5
Resulting Characteristics-Comparison of Embodiments of the Aqueous Polymer Dispersion

| | EX. 1 | EX. 2 | EX. 3 | EX. 4 | EX. 5 | EX. 6 | EX. 7 | EX. 8 | EX. 9 |
|---|---|---|---|---|---|---|---|---|---|
| pH | 5.67 | 5.84 | 5.6 | 5.58 | 5.71 | 5.8 | 5.69 | 5.86 | 5.86 |
| SP | 59.75 | 59.53 | 59.92 | 61.57 | 59.88 | 59.72 | 60.02 | 60.05 | 60.11 |
| Visc | 145 | 375 | 70 | 100 | 75 | 100 | 115 | 100 | 115 |
| Grit | 0 | 152.47 | 0 | 0.19 | 0.17 | 0.2 | 0.15 | 0.13 | 0.16 |
| RMC | 1576 | 1692 | 1386 | 1982 | 910.5 | 1449 | 1672 | 1110 | 1454 |
| 50 PS | 326 | 282 | 490 | 695 | 496 | 394 | 431 | 602 | 366 |
| 95 PS | 930 | 402 | 949 | 1144 | 1289 | 1065 | 1012 | 986 | 794 |
| Mᵥ PS | 433 | 353 | 503 | 644 | 603 | 499 | 495 | 558 | 403 |
| Mₙ PS | 241 | 267 | 171 | 197 | 182.3 | 252.2 | 193.6 | 190.1 | 204 |
| PDI | 1.8 | 1.32 | 2.94 | 3.27 | 3.31 | 1.98 | 2.56 | 2.94 | 1.98 |
| LPSP | Small | Uni | Large | Large | Small | Small | Large | Large | Large |
| PSR | $\frac{74}{26}$ | $\frac{95.7}{4.3}$ | $\frac{19.3}{80.7}$ | $\frac{20}{80}$ | $\frac{70.1}{29.9}$ | $\frac{66.3}{33.7}$ | $\frac{46.1}{53.9}$ | $\frac{29.2}{70.8}$ | $\frac{45}{55}$ |
| OPSD | Bi | Uni | Bi | Bi | Bi | Bi | Bi | Bi | Bi |
| T_{g} | −36 | −36 | −35 | −36 | −40 | −32 | −33 | −39 | −25 |

TABLE 6
Standard Testing Results - Comparison for Embodiments of the Aqueous Polymer Dispersion

| | EX.1 | EX. 2 | EX. 3 | EX. 4 | EX. 5 | EX. 6 | EX. 7 | EX. 8 | EX. 9 |
|---|---|---|---|---|---|---|---|---|---|
| PL 15 M (SS) | 2.175 | 1.806 | 2.66 | 2.436 | 1.972 | 2.002 | 2.078 | 1.86 | 1.86 |
| PL 1 H (SS) | 2.864 | | 2.563 | 2.082 | 1.64 | 1.88 | 2.014 | 1.884 | 1.585 |
| PL 24 H (SS) | 3.719 | 2.441 | 5.033 | 3.645 | 3.694 | 3.16 | 3.968 | 3.158 | 2.716 |
| PL 15 M (G) | 2.362 | 1.605 | 2.21 | 1.947 | 1.73 | 1.57 | 1.968 | 1.991 | 1.713 |
| PL 1 H (G) | 2.474 | | 2.085 | 1.954 | 1.355 | 1.561 | 2.047 | 1.75 | 1.767 |
| PL 24 H (G) | 3.344 | 1.607 | 2.472 | 1.651 | 1.299 | 1.801 | 2.618 | 1.557 | 1.736 |
| LT (SS) | 2.378 | 2.398 | 3.038 | 2.872 | 2.426 | 2.256 | 2.856 | 2.464 | 1.708 |
| LT (G) | 2.246 | 3.086 | 3.098 | 2.912 | 2.464 | 2.184 | 2.512 | 2.156 | 2.518 |
| Shear | 8800 | 540.6 | 853 | 1179 | 586 | 2195 | 6157 | 3474 | 10000 |
| PL IM 1 H (SS) | 3.318 | 5.048 | 3.084 | 4.305 | 4.269 | 2.975 | 4.548 | 4.338 | 3.008 |
| PL IM 24 H (SS) | 3.365 | 4.658 | 2.2895 | 2.228 | 3.235 | 3.029 | 3.782 | 4.114 | 2.362 |
| IM DEL | 0.354 | 2.217 | 2.744 | 1.417 | 0.459 | 0.131 | 0.186 | 0.956 | |
| PL KOH IM 1 H | 3.444 | 4.973 | 5.234 | 4.161 | 3.914 | 3.245 | 5.015 | 4.57 | 2.586 |
| (SS) | | | | | | | | | |
| PL KOH IM | 3.825 | 3.934 | 4.417 | 4.342 | 4.068 | 4.004 | 2.285 | 3.802 | 1.731 |
| 24 H (SS) | | | | | | | | | |
| KOH IM DEL | 0.106 | 1.493 | 0.616 | 0.697 | 0.374 | 0.844 | 1.683 | 0.644 | |
| Haze 1 H | 4.3 | 17.2 | 39.4 | 11.8 | 10.53 | 4.77 | 4.87 | 5.2 | 5.13 |
| Haze 24 H | 17.9 | 82.1 | 83.5 | 72.4 | 67.9 | 17.9 | 18.9 | 25.56 | 29.77 |
| DINP | Pass | Fail | Medium | Fail | Fail | Fail | Fail | Fail | Fail |

### Effect of Changing Particle Size Distribution:

Tables 5 and 6 demonstrate the effect of changing the particle size distribution of the aqueous polymer dispersion from that of unimodal (in Example 2) to bimodal (in Example 1). With the exception of Acrylic Seed II, Examples 1 and 2 comprise the same components of similar amount. Table 5 shows that the addition of Acrylic Seed II results in an aqueous polymer dispersion that has a bimodal particle size distribution. Table 6 shows the affect that this bimodal particle size distribution has on the adhesive characteristics in Example 1. By changing the particle size distribution from unimodal to bimodal, the peel strength and the shear strength of the aqueous polymer dispersion may significantly and simultaneously increase.

### Effect of Removing Components:

Table 5 and 6 demonstrate the effect of removing components from the aqueous polymer dispersion of Example 1. For instance, in Example 3 the Sipomer® B-CEA component was removed from the solution. As shown in Table 6, this resulted in a significant decrease in the shear strength of the aqueous polymer dispersion of Example 3. In Example 4, the tripotassium phosphate component was removed. Once again, absence of a particular component, in this case tripotassium phosphate, results in a significant decrease in the shear strength. Further, absence of this particular component also affects the water resistance as well as the alkaline resistance of the aqueous polymer dispersion of Example 4. Water resistance may be measured by both haze, or blush resistance, and peel immersion delta after soaking in water. Additionally, alkaline resistance may be similarly measured with the immersion delta after soaking in a KOH solution. In Example 4, table 6 illustrates an increase in haze, a failure in Diisononyl Phthalate Drop Test, and changes in the immersion results. As such, both water and alkaline resistance change dramatically when individual components are removed from the aqueous polymer dispersion. Overall, Examples 3 and 4 illustrate that the omission of any components from the aqueous polymer dispersion of Example 1 may have negative affects on the adhesive properties and the water and alkaline resistance.

### Effect of Shifting the T_{g}:

Tables 5 and 6 demonstrate the effect of shifting the glass transition temperature of the aqueous polymer dispersion of Example 1. Examples 5 through 9 show that in shifting the T_{g} both above and below −36° C., an aqueous polymer dispersion with both an overall balance of adhesive properties and a high water resistance may not be obtainable. Therefore, in order for an aqueous polymer dispersion to achieve high tack, high peel strength, and high shear strength, while maintaining high water resistance, a T_{g} similar to that of Example 1 should be used.

### Comparative Example 10

The previous examples, particularly Example 1, have demonstrated that changing the particle size distribution of the aqueous polymer dispersion in Example 1 from unimodal to bimodal, has an unexpected result of an overall balance of adhesive properties (i.e. results in high tack, high peel strength, and high shear strength). However, changing the particle size distribution in this way does not have the same effect on aqueous polymer dispersions of different composition. Although not disclosed herein, a different aqueous polymer dispersion with a different set of components was manipulated similarly to that of Example 1 in order to change from a unimodal to a bimodal particle size distribution. The results are shown in Tables 7 and 8.

TABLE 7
Resulting Characteristics - Comparison of an Aqueous
Polymer Dispersion with Different Components

| | EX. 1 | EX. 10 |
|---|---|---|
| pH | 5.67 | 2.7 |
| SP | 59.75 | 68.91 |
| Visc | 145 | 1643 |
| Grit | 0 | 6.66 |
| RMC | 1576 | 4050 |
| 50 PS | 326 | 332 |
| 95 PS | 930 | 869 |
| Mᵥ PS | 433 | 401 |
| Mₙ PS | 241 | 277 |
| PDI | 1.8 | 1.45 |
| LPSP | Small | Small |
| PSR | $\frac{74}{26}$ | |
| PD | Bimodal | Bimodal |
| T_{g} | −36 | −45 |

TABLE 8
Standard Testing Results - Comparison of an Aqueous
Polymer Dispersion with Different Components

| | EX. 1 | EX. 10 |
|---|---|---|
| PL 15 M (SS) | 2.175 | 2.115 |
| PL 1 H (SS) | 2.864 | |
| PL 24 H (SS) | 3.719 | 3.667 |
| PL 15 M (G) | 2.362 | 1.259 |
| PL 1 H (G) | 2.474 | |
| PL 24 H (G) | 3.344 | 1.024 |
| LT (SS) | 2.378 | 2.718 |
| LT (G) | 2.246 | 2.66 |
| Shear | 8800 | 88.8 |
| PL IM 1 H (SS) | 3.318 | 3.373 |
| PL IM 24 H (SS) | 3.365 | 2.328 |
| PL KOH IM 1 H (SS) | 3.444 | 3.436 |
| PL KOH IM 24 H (SS) | 3.825 | 2.093 |
| Haze 1 H | 4.3 | 36.3 |
| Haze 24 H | 17.9 | 82.97 |
| DINP | Pass | Pass |

Tables 7 and 8 demonstrate that changing the particle size distribution of any aqueous polymer dispersion does not result in an overall balance of adhesive properties. For instance, the shear strength in Example 2 is significantly less than that of Example 1, despite the fact that each composition was manipulated to have a bimodal particle size distribution. Therefore, Example 10 illustrates that changing the particle size distribution of an aqueous polymer dispersion, in order to increase tack, peel strength, and shear strength, is specific to an aqueous polymer dispersion comprising the components of Example 1.

Although the present invention and its advantages have been described in detail, it should be understood that various changes, substitutions and alterations may be made herein without departing from the spirit and scope of the invention as defined by the appended claims. Furthermore, although individual embodiments may have been discussed the invention is intended to also cover combinations of those embodiments.

What is claimed is:

1. An aqueous polymer dispersion comprising:
(A) between 0 wt. % to 2.0 wt. % of at least one unsaturated carboxylic acid;
(B) between 0 wt. % to 9.0 wt. % of an acetate ester;
(C) between 40.0 wt. % to 55.0 wt. % of at least one acrylate monomer;
(D) between 0 wt. % to 1.0 wt. % of at least one hydroxyl functional (meth)acrylic monomer;
(E) between 0 wt. % to 1.0 wt. % of at least one formulation stabilizer; and
a bimodal particle size distribution, wherein the bimodal particle size distribution contributes to an overall balance of adhesive properties in an aqueous polymer dispersion comprising components (A) through (E).

2. The aqueous polymer dispersion of claim 1, further comprising (F) optionally, at least one free radical initiator, (G) optionally, at least one surfactant, and (H) optionally, preserving agents and/or biocides.

3. The aqueous polymer dispersion of claim 1, wherein the at least one unsaturated carboxylic acid comprises an unsaturated monocarboxylic acid, such as acrylic acid, methacrylic acid, hydracrylic acid, crotonic acrylic acid, β-carboxyethyl acrylate, vinyl acetic acid, and vinyl lactic acid.

4. The aqueous polymer dispersion of claim 1, wherein the acetate ester comprises methyl acetate, ethyl acetate, isopropyl acetate, vinyl acetate, ethylhexyl acetate, or any combinations thereof.

5. The aqueous polymer dispersion of claim 1, wherein the at least one acrylate monomer comprises a first acrylate monomer and a second acrylate monomer.

6. The aqueous polymer dispersion of claim 5, wherein the first acrylate monomer comprises ethyl acrylate and the second acrylate monomer comprises butyl acrylate.

7. The aqueous polymer dispersion of claim 1, wherein the at least one hydroxyl functional (meth)acrylic monomer comprises a C₂-C₈ hydroxyalkyl.

8. The aqueous polymer dispersion of claim 1, wherein the at least one formulation stabilizer comprises Tris(2,4-di-tert-butylphenyl)phosphite, butylated hydroxytoluene, tripotassium phosphate, monomers from the sipomer series, or any combinations thereof.

9. The aqueous polymer of claim 1, wherein the components (A) through (E) contribute to high levels of water resistance for the aqueous polymer dispersion.

10. The aqueous polymer of claim 1, wherein the components (A) through (E) contribute to high levels of alkaline resistance for the aqueous polymer dispersion.

11. A method for making an aqueous polymer dispersion comprising:
polymerizing a set of monomers comprising the following components:
(A) between 0 wt. % to 2.0 wt. % of at least one unsaturated carboxylic acid;
(B) between 0 wt. % to 9.0 wt. % of an acetate ester;
(C) between 40.0 wt. % to 55.0 wt. % of at least one acrylate monomer;
(D) between 0 wt. % to 1.0 wt. % of at least one hydroxyl functional (meth)acrylic monomer; and
(E) between 0 wt. % to 1.0 wt. % of at least one formulation stabilizer,
wherein a bimodal particle size distribution contributes to an overall balance of adhesive properties in an aqueous polymer dispersion comprising components (A) through (D).

12. The method of claim 11, wherein the set of monomers further comprise (F) optionally, at least one free radical initiator, (G) optionally, at least one surfactant, and (H) optionally, preserving agents and/or biocides.

13. The method of claim 11, wherein the at least one unsaturated carboxylic acid comprises an unsaturated monocarboxylic acid, such as acrylic acid, methacrylic acid, hydracrylic acid, crotonic acrylic acid, β-carboxyethyl acrylate, vinyl acetic acid, and vinyl lactic acid.

14. The method of claim 11, wherein the acetate ester comprises methyl acetate, ethyl acetate, isopropyl acetate, vinyl acetate, ethylhexyl acetate, or any combinations thereof.

15. The method of claim 11, wherein the at least one acrylate monomer comprises a first acrylate monomer and a second acrylate monomer.

16. The method of claim 12, wherein the first acrylate monomer comprises ethyl acrylate and the second acrylate monomer comprises butyl acrylate.

17. The method of claim 11, wherein the at least one hydroxyl functional (meth)acrylic monomer comprises a C₂-C₈ hydroxyalkyl.

18. The method of claim 11, wherein the at least one formulation stabilizer comprises Tris(2,4-di-tert-butylphenyl)phosphite, butylated hydroxytoluene, tripotassium phosphate, monomers from the sipomer series, or any combinations thereof.

19. The method of claim 11, wherein the components (A) through (E) contribute to high levels of water resistance for the aqueous polymer dispersion.

20. The method of claim 11, wherein the components (A) through (E) contribute to high levels of alkaline resistance for the aqueous polymer dispersion.
